(19) United States
(12) Patent Application Publication
(10) Pub. No.: US 2023/0072497 A1
(43) Pub. Date: Mar. 9, 2023

(54) SYSTEM FOR MANAGING PLACING RETAIL PRODUCTS ON STORE SHELVES

(71) Applicants: SHMUEL MAZUZ, RAMAT GAN (IL); SLOMO BEN ABET, KEFAR SAVA (IL); RON MAZUZ, KEFAR SAVA (IL); YEHOSHUA MALIACH, KEFAR SAVA (IL)

(72) Inventor: SHMUEL MAZUZ, RAMAT GAN (IL)

(21) Appl. No.: 17/847,212

(22) Filed: Jun. 23, 2022

(30) Foreign Application Priority Data
Sep. 5, 2021 (IL) 286135

(51) Int. Cl. G06Q 10/08; G09F 3/20

(52) U.S. Cl. CPC G06Q 10/087; G09F 3/204; G09F 3/208

(57) ABSTRACT

A system for managing placing retail products on store shelves, the system including a plurality of cameras, each for capturing at least one of the retail products and for capturing a visual identification thereof, a plurality of screens, each for being captured by one of the cameras and for being identifiable thereby, and a server for determining for each of the identified screens, nearness thereof to at least one of the identified retail products, and for transferring to that screen information of the at least one determined retail product, thereby each of the screens displays the information of the retail products disposed near thereto as determined, and not of other retail products.

### TECHNICAL FIELD

The invention relates to the field of planograms. More particularly, the invention relates to managing placing retail products on store shelves.

### BACKGROUND

Correct design of placing retail products on shelves of a store, and changing thereof along time, increases the sells.

However, changes of the design renders changes of notices and announcements to the public and to the staff, such as of pricing, which must be addressed by computerized solutions.

There is a long felt need to provide a solution to the above-mentioned and other problems of the prior art.

### SUMMARY

A system for managing placing retail products on store shelves, including:
cameras for capturing the retail products;
screens; and
a server for determining for each of the identified screens, nearness thereof to the retail products.

### BRIEF DESCRIPTION OF THE DRAWINGS

Embodiments, features, and aspects of the invention are described herein in conjunction with the following drawings:

FIG. 1 is a side view of a system for managing retail products on store shelves according to one embodiment of the invention, working on a first exemplary placement of retail products.

FIG. 2 depicts the display of the screens of FIG. 1.

FIG. 3 depicts additional members of the planogram system of FIG. 1 and the communication therebetween.

FIG. 4 depicts the analysis of the server of FIG. 3.

FIG. 5 is a front view of the screen and products of FIG. 1.

FIG. 6 depicts the system of FIG. 1 applied to a second exemplary placement of retail products.

FIG. 7 depicts the display of the screens of FIG. 6.

FIG. 8 depicts the analysis of the server for the exemplary placement of FIG. 6.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

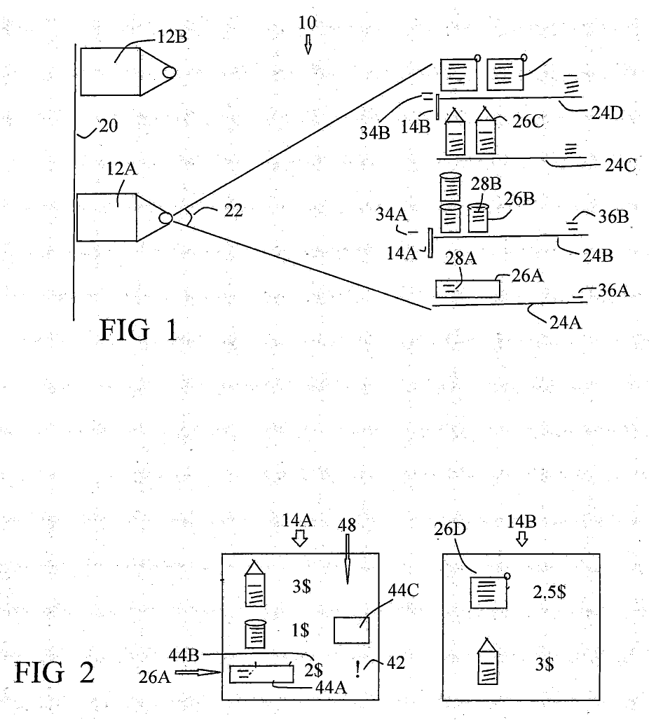

FIG. 1 is a side view of a system for managing retail products on store shelves according to one embodiment of the invention, working on a first exemplary placement of retail products.

A system 10 for managing placing of retail products on store shelves according to one embodiment of the invention, includes a plurality of cameras 12A, 12B, etc. distributed in the store; and a plurality of movable screens 14A, 14B, etc.

Cameras 12A and 12B are fixed to a wall 20, thus the angle of view 22 of each camera is limited to certain shelves, being 24A, 24B, 24C and 24D in the example for camera 12A.

The term “planogram” refers herein to diagram or model that indicates the desired placement of retail products on shelves in order to maximize sales.

At a first exemplary placement of retail products on shelves, retail products of type 26A are currently placed on shelf 24A; retail products of type 26B are currently placed on shelf 24B; retail products of type 26C are currently placed on shelf 24C; and retail products of type 26D are currently placed on shelf 24D, all according to the planogram being the plan of the retail products-organizer or computerized application or planogram-manager.

Camera 12A captures the product barcode 28A of retail products 26A, product barcode 28B of retail products 26B, etc., and further captures the quantity of each type of retail products placed on the shelf, and the empty space on the shelf.

Camera 12A further captures the identification 34A of screen 14A, such as a barcode thereof; and identification 34B of screen 14B.

Camera 12A further captures the identification 36A of shelf 24A, such as a barcode thereof; and identification 36B of shelf 24B; etc.

Thus, camera 12A maps identified retail product 26A to store shelf 24A. The plurality of cameras form a complete map of the disposition of all of the retail products on the shelves, and the utilization of volumes of the products in relation to the volume being available by the shelves, and compares it to preferred models of placements for increasing the sells.

According to the example, screen 14A is currently placed near shelves 24A, 24B and 24C; and screen 14B is currently placed near shelves 24C and 24D.

FIG. 2 depicts the display of the screens of FIG. 1.

Accordingly, screen 14A displays information 48 of retail products 26A, 26B and 26C placed on shelves 24A, 24B and 24C; and screen 14B displays information of retail products 26C and 26D placed on shelves 24C and 24D.

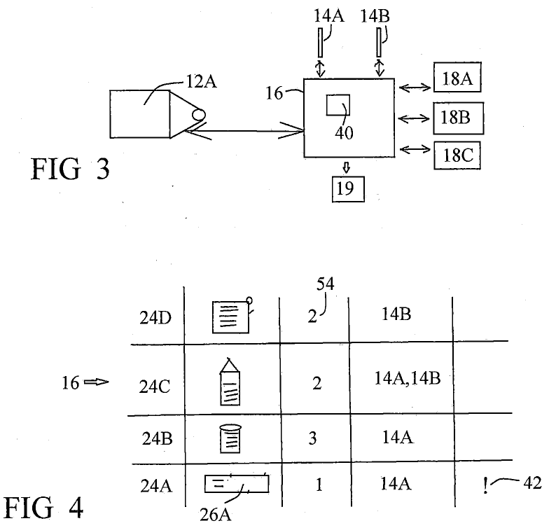

FIG. 3 depicts additional members of the planogram system of FIG. 1 and the communication therebetween.

Camera 12A provides its constant location; its captures of retail products 26A, 26B, etc. and the barcodes thereof; its captures of screens 14A, 14B, etc. and the barcodes thereof; its captures of shelves 24A, 24B, etc. and the barcodes thereof; all along time to a server 16 including an image processor 40.

Server 16 further retrieves prices, images and advertisements of retail products 26A, 26B, etc. of the store from a database 18A; and retrieves the inventory of the retail products of the store from a database 18B.

FIG. 4 depicts the analysis of the server of FIG. 3.

Server 16 analyzes the captures and identifications of the objects to the data of FIG. 4, being (herein the bottom line of FIG. 4) shelf 24A containing quantity 54 being 1 product of type 26A, and determines that screen 14A is disposed near product 26A. Server finds the price, image and advertisement of product 26A in database 18A.

The determination of the nearness of the retail product to the screen for being displayed thereby is a function of the design of the display according to planogram considerations, such as of a selection how many retail products are to be displayed by each screen; or dedicating a certain screen to a single retail product for preferring the selling thereof.

Thus, and referring to FIG. 2, server 16 transmits an instruction to screen 14A to display information 48 of product 26A, such as image 44A, price 44B and advertisement 44C.

Referring to FIG. 1, since the capture of product 26A includes a small quantity (only 1 in the example), server 16 may transmit an instruction to screen 14A to alert (42) to the shelf organizer to add products of type 26A. Alert 42 may as well be transferred to appliances and servers 19 outside the shelves.

Referring to FIG. 3, server 16 may compare the actual mapping of retail products placed on the shelves, to the planned mapping being the planogram, retrieved from database 18C.

The planogram according to the invention further includes the placement of the screens and the information displayed thereby.

In the same manner, server 16 analyzes shelf 24D contains 2 products 26D, and that screen 14B is disposed near products 26D. Thus, server 16 transmits an instruction to screen 14B to display information including image, price and advertisement of product 26D.

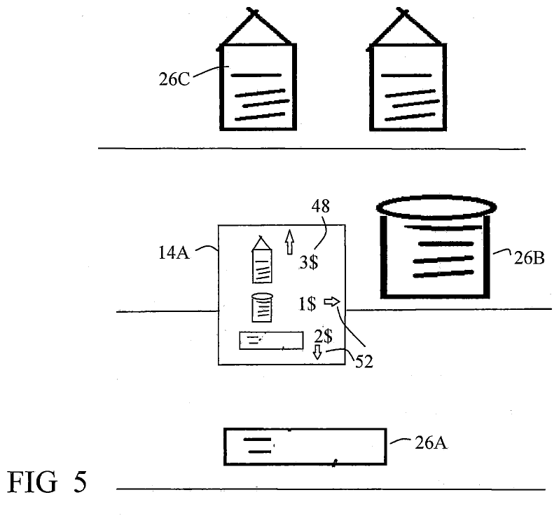

FIG. 5 is a front view of the screen and products of FIG. 1.

Information 48 displayed by screen 14A may further include an indication 52 that retail product 26A is placed below screen 14A. This information may be analyzed from the capturing of screen 14A and of retail product 26A.

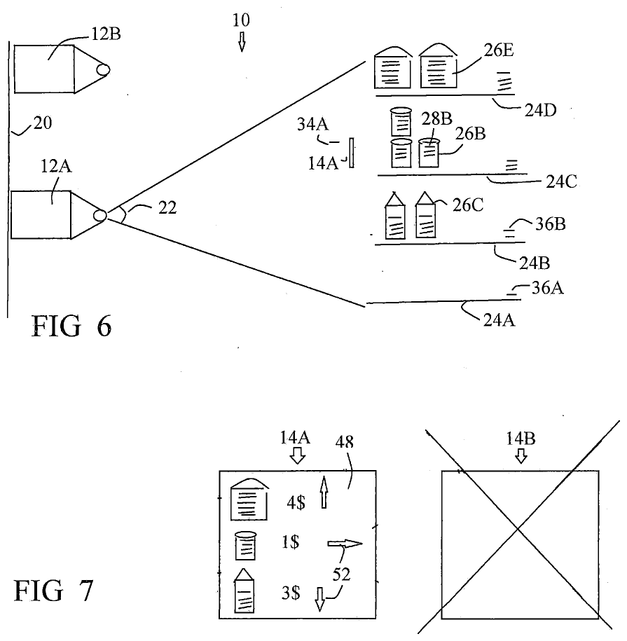

FIG. 6 depicts the system of FIG. 1 applied to a second exemplary placement of retail products.

At a second exemplary placement of retail products, retail products of type 26A is absent; retail products of type 26B has changed its location to shelf 24C; retail products of type 26C has changed its location to shelf 24B; and new retail products of type 26E are placed on shelf 24D.

According to the second example, screen 14A is currently placed near shelves 24B, 24C and 24D; and screen 14B is absent.

FIG. 7 depicts the display of the screens of FIG. 6.

Accordingly, screen 14A displays information of retail products 26B, 26C and 26E.

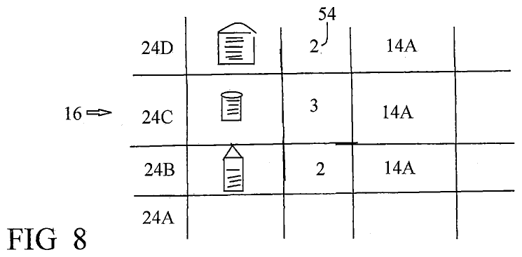

FIG. 8 depicts the analysis of the server for the exemplary placement of FIG. 6.

Thus, and referring to FIG. 7, server 16 transmits an instruction to screen 14A to display information of products products 26B, 26C and 26E, and manages the changes of the locations of products 26B and 26C.

Thus, in one aspect, the invention is directed to a system (10) for managing placing retail products on store shelves (24A), the system including:
a plurality of cameras (12A,12B), each for capturing at least one (26A) of the retail products and for capturing a visual identification (28A) thereof;
a plurality of screens (14A,14B), each for being captured by one (12A) of the cameras and for being identifiable thereby; and
a server (16) for determining for each of the identified screens (14A), nearness thereof to at least one (26A) of the identified retail products, and for transferring to that screen (14A) information (48) of the at least one (26A) determined retail product,
   thereby each of the screens (14A) displays the information (48) of the retail products disposed near thereto as determined, and not of other retail products.

Each (14A) of the screens is movable in relation to the shelves (24A),
thereby allowing changing the displaying of the information (48) by that screen to at least another retail product disposed near that screen, and
thereby allowing changing the camera capturing that screen.

The displaying by each (14A) of the screens of the information (48) of the at least one (26A) retail product determined to be disposed near to that screen, may include displaying by that screen an indication (52) of a location of the determined retail product in relation to a location of that screen.

The determined nearness may be a function of planogram considerations, being:
volume of retail products for being informed by each screen;
dedicating a screen to retail products for preferring the selling thereof.

The system (10) may further include;
an identification (36A) for each of the store shelves (24A) for being capturable and identifiable by at least one (12A) of the cameras,
   thereby mapping each (26A) of the identified retail products to each (24A) of the identified store shelves.

The displayed information (48) of the at least one (26A) determined product may include: price, product image, advertisement thereof.

Appliance 19 may receive alerts (42) from the information (48) determined by the server (16).

In the figures and/or description herein, the following reference numerals (Reference Signs List) have been mentioned:
numeral 10 denotes the system for managing placing of retail products on store shelves according to one embodiment of the invention;
12A,12B: cameras;
14A,14B: screens for displaying information of retail products disposed near the screen;
16: server;
18A: database of the store including prices and advertisements of the retail products;
18B: database including inventory of the store's retail products;
18C: database including the planogram of the store;
19: appliance or server for receiving alerts;
22: angle of view;
24A,24B,24C,24D: shelves;
26A,26B,26C,26D: retail products;
34A26E,34B: visual identification of screens such as printed barcodes;
36A,36B: visual identification of shelves such as printed barcodes;
40: image processor for reading barcodes and for analyzing quantity of retail products, and for analyzing utilization of volume of retail products in relation to available volume of the shelf, and for other tasks;
42: visual and/or audible alert;
44A: image of retail product;
44B: price of retail product;
44C: advertisement of retail product;
48: information displayed by the screen;
52: indication within the display of the screen, where the physical retail product is located in relation to the screen, according to image processing of the capture including the screen and the retail product;
54: quantity being accurate or estimated, of retail products placed on the shelf;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A system (10) for managing placing retail products on store shelves (24A), the system comprising:
a plurality of cameras (12A,12B), each for capturing at least one (26A) of said retail products and for capturing a visual identification (28A) thereof;
a plurality of screens (14A,14B), each for being captured by one (12A) of said cameras and for being identifiable thereby; and
a server (16) for determining information (48) from said cameras (12A,12B), and for determining for each of said identified screens (14A), nearness thereof to at least one (26A) of said identified retail products, and for transferring to that screen (14A) from said information (48) of said at least one (26A) determined retail product,
thereby each of said screens (14A) displays said information (48) of said retail products disposed near thereto as determined, and not of other retail products.

2. The system (10) according to claim 1, wherein each (14A) of said screens is movable in relation to said shelves (24A),
thereby allowing changing said displaying of said information (48) by that screen to at least another retail product disposed near that screen, and
thereby allowing changing the camera capturing that screen.

3. The system (10) according to claim 1, wherein said displaying by each (14A) of said screens of said information (48) of said at least one (26A) retail product determined to be disposed near to that screen, comprises displaying by that screen an indication (52) of a location of said determined retail product in relation to a location of that screen.

4. The system (10) according to claim 1, wherein said determined nearness is a function of considerations, comprising at least one member selected from a group consisting of:
volume of retail products for being informed by each screen;
dedicating a screen to retail products for preferring the selling thereof.

5. The system (10) according to claim 1, wherein a planogram (18C) of said store comprises said screens and said information displayed thereby.

6. The system (10) according to claim 1, wherein said server (16) is configured to compare a planogram (18C) of said store to said captures comprising said retail products and said screens.

7. The system (10) according to claim 1, further comprising:
an identification (36A) for each of said store shelves (24A) for being identifiable by at least one (12A) of said cameras,
thereby mapping each (26A) of said identified retail products to each (24A) of said identified store shelves.

8. The system (10) according to claim 1, wherein said displayed information (48) of said at least one (26A) determined product comprises at least one member selected from a group consisting of: price, product image, advertisement thereof, quantity alert.

9. The system (10) according to claim 1, further comprising at least one appliance (19) for receiving alerts (42) from said information (48) determined by said server (16).
